(19) United States
(12) Patent Application Publication
(10) Pub. No.: US 2015/0204375 A1
(43) Pub. Date: Jul. 23, 2015

(54) COMPONENT CONNECTION COMPRISING AT LEAST TWO CFC COMPONENTS

(71) Applicant: SCHUNK KOHLENSTOFFTECHNIK, Heuchelheim (DE)

(72) Inventors: Jeremias Schönfeld, Huettenberg (DE); Gotthard Nauditt, Huettenberg (DE); Roland Weiß, Huettenberg (DE); Martin Henrich, Wetzlar (DE)

(21) Appl. No.: 14/420,739

(22) PCT Filed: Jul. 18, 2013
(86) PCT No.: PCT/EP2013/065206

§ 371 Date: Feb. 10, 2015

(30) Foreign Application Priority Data
Aug. 13, 2012 (DE) 10 2012 214 407.2

(51) Int. Cl. F16B 39/24; F16B 33/00

(52) U.S. Cl. CPC F16B 39/24; F16B 33/006

(57) ABSTRACT

The invention relates to a component connection comprising at least two CFC components that are interconnected in a force-fitting manner by means of a connecting system exclusively having connecting elements consisting of CFC or graphite, the component connection having a spring element (42) consisting of a CFC material.

The invention relates to a component connection comprising at least two CFC components that are interconnected in a force-fitting manner by means of a connecting system exclusively having connecting elements consisting of CFC or graphite.

Component connections between CFC components are generally used in all cases in which CFC components are employed as structural elements of machine parts or support structures. Apart from static or dynamic mechanical stresses, other stresses, such as in particular thermal stresses, occur because of special environmental conditions as a function of the type of use that influence the creep rupture strength of a connection.

For instance, CFC components are also employed in circulation devices that are used in industry furnaces for redistributing or homogeneously mixing a furnace atmosphere. Furnaces of this kind are used for performing thermal processes in which carbon materials are subjected to pyrolysis or in which carbon components are carbonized or graphitized, for example.

Irrespective of the individual processes taking place in an industry furnace, the circulation devices used therein are exposed to massive thermal stresses because temperatures of 2000° C. or more are reached at times in the furnace atmosphere. Because of these high thermal stresses, materials are now routinely used for the circulation devices that are characterized by a particularly low coefficient of thermal expansion so that thermally induced tensions in the used materials can thus be limited. Carbon fiber-reinforced carbon (CFC) has proved to be a particularly suitable construction material for circulation devices owing to its high-temperature resistance and its low weight. It is problematic, however, that because of its fiber orientation, carbon fiber-reinforced carbon exhibits a pronounced anisotropy, which causes CFC to have a significantly lower coefficient of thermal expansion in the direction of the fibers than vertically to the direction of the fibers. For example, in connections between CFC components that are formed by a screw connection, which have connecting elements consisting of CFC or graphite, such as a threaded bolt consisting of CFC, which is clamped to the CFC components by means of graphite nuts, significant mechanical tensions may consequently occur in the area of the screw connection if the fibers of the CFC components and of the connecting bolt are oriented crosswise.

Since CFC has an extremely porous form in particular in the area between the fibers, these tensions may lead to settling phenomena in the area of the screw connection, which can result in a loosening of the originally force-fitting screw connection between the CFC components in the course of the temperature treatment and in component failure.

One possibility of preventing such a component failure is to define maintenance intervals as a function of the occurring temperature stress in order to be able to replace the screw connections in time before components fail. Since performing the maintenance or inspection of the circulation devices and in particular eventually necessary repairs are accompanied by enormous effort, it is the object of the present invention to enhance component connections, in particular those used in circulation devices, and to propose a suitable method for producing component connections of this kind to the effect that a permanent force-fitting connection between the CFC components becomes possible.

To attain this object, the component connection according to the invention has the features of claim 1.

First of all, the component connection according to the invention comprises at least two CFC components to be interconnected that are interconnected in a force-fitting manner by means of a connecting system exclusively having connecting elements consisting of CFC or graphite, the component connection having a spring element consisting of a CFC material.

By using the CFC spring element, it is possible to compensate settling phenomena in a force-fitting connection between two CFC components by means of the effect of the spring element without the use of a material other than the material of the CFC components being necessary.

While it is of course generally known to use a spring element for compensating settling phenomena on screw connections, these known spring elements consisting of metal cannot be used in the circulation device according to the invention since the latter is especially intended to be employed in a high-temperature environment. At the temperatures in question, which quite often reach 2000° C. and beyond, the creep limit of metals, for example, is exceeded by far so that the desired compensating spring effect is no longer available in the afore-mentioned temperature range. By using a spring element consisting of a CFC material, the use of spring elements compensating settling phenomena in screw connections that have to permanently ensure a force-fitting connection between the components interconnected by means of the screw connection even under high-temperature conditions becomes possible for the first time.

In the major number of cases, it is advantageous to realize the connecting system between the CFC components as a screw-connection device that has a threaded bolt consisting of a CFC material and at least one nut consisting of a graphite material, the spring element being arranged between the nut and a CFC component in such a manner that a pressure force is active between the nut and the CFC component.

Very basically, the use of the spring elements consisting of a CFC material is of course not limited to the combination with a connecting system realized as a screw-connection device. Instead, spring elements consisting of a CFC material can also be used for compensating settling phenomena in other force-fitting connecting systems, such as a clamping or wedging connection, which allow a mechanically pre-tensioned connection for a force-fitting effect in the same manner as a screw connection.

It is particularly advantageous if the threaded bolt is provided with a bolt head and if the threaded bolt penetrates two CFC components that are to be interconnected in a force-fitting manner and that are arranged between the bolt head of the threaded bolt and the nut so that the CFC spring element can be generally used in the same manner as a conventional steel spring element, whose use is excluded in the circulation device according to the invention for the afore-discussed reasons.

An overall simple structure of the connecting system including a smallest possible number of different components becomes possible if the bolt head is formed by a nut consisting of a graphite material.

In a particularly preferred embodiment of the circulation device, the number of components can be reduced even further if the threaded bolt is formed on a first one of the CFC components that are interconnected in a force-fitting manner and penetrates the other CFC component, which is arranged between the first CFC component and the nut.

In another preferred embodiment, the spring element is realized as a beam spring element and is provided with two support legs for support on a CFC component and an elastic beam connecting the support legs for support on the bolt head or the nut of the connecting system.

Alternatively, in another embodiment, it is also possible to realize the spring element as an annular spring element, including a spring ring that has support legs on two opposite axial surfaces, said support legs being arranged on the axial surfaces in a radially distributed manner so that a support leg formed on one axial surface is located between two support legs formed on the opposite axial surface.

It is particularly advantageous for the effectiveness of the spring elements if at least the elastic beam of the beam spring element or the spring ring of the annular spring element has a fiber orientation with fibers that extend along a stress axis that connects the support legs.

If the component connection is realized on a circulation device for circulating an ambient atmosphere, the circulation device having a plurality of components that comprise at least a shaft for connecting the circulation device to a driving device, a blade carrier connected to the shaft and a plurality of blades arranged on the blade carrier for applying a flow impulse to the atmosphere, at least the blade carrier and the blades are realized as CFC components between which the component connection is formed.

In this way, a permanently force-fitting connection between interconnected CFC components of the circulation device is made possible so that settling phenomena due to a gap formation between the interconnected components and a resulting interruption of the force fit are prevented by the material-bonded connection.

In the following, preferred embodiment examples of the invention will be explained in more detail with the aid of the drawing.

In the figures:

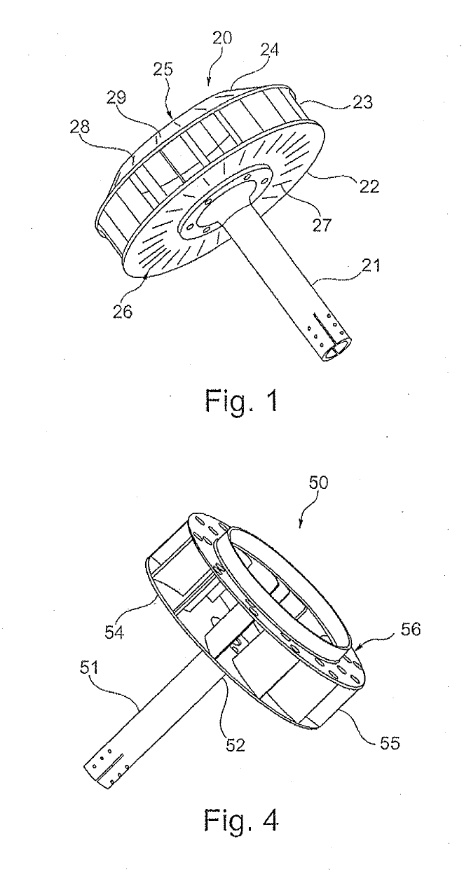

FIG. 1: shows a first embodiment of a circulation device in an isometric illustration;

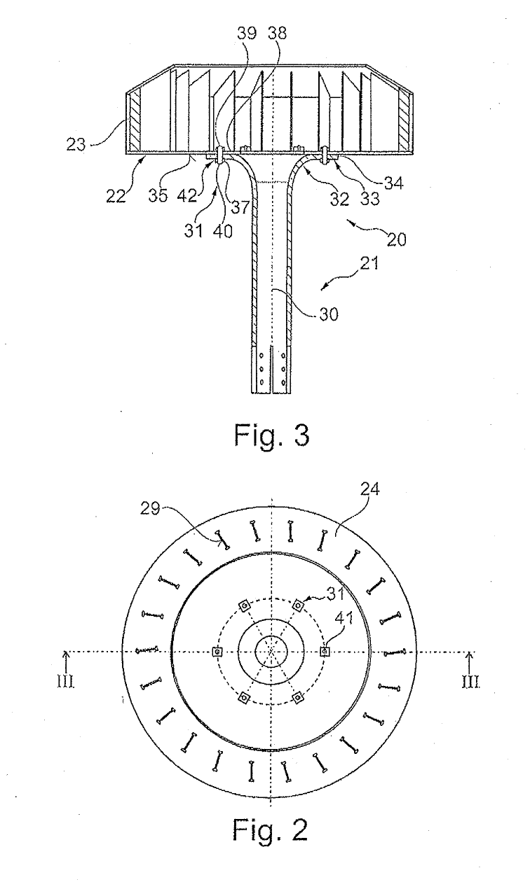

FIG. 2: shows the circulation device illustrated in FIG. 1 in a top view;

FIG. 3: shows the circulation device illustrated in FIG. 2 in a sectional view according to section line in FIG. 2;

FIG. 4: shows another embodiment of a circulation device in an isometric illustration;

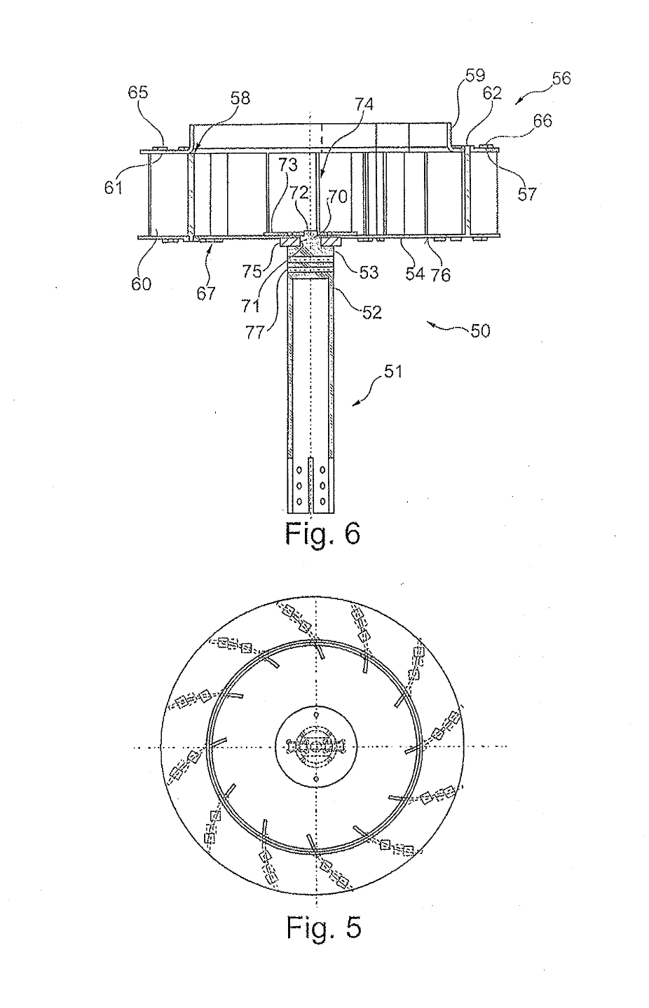

FIG. 5: shows the circulation device illustrated in FIG. 4 in a top view;

FIG. 6: shows the circulation device illustrated in FIG. 5 in a sectional view according to section line VI-VI in FIG. 5;

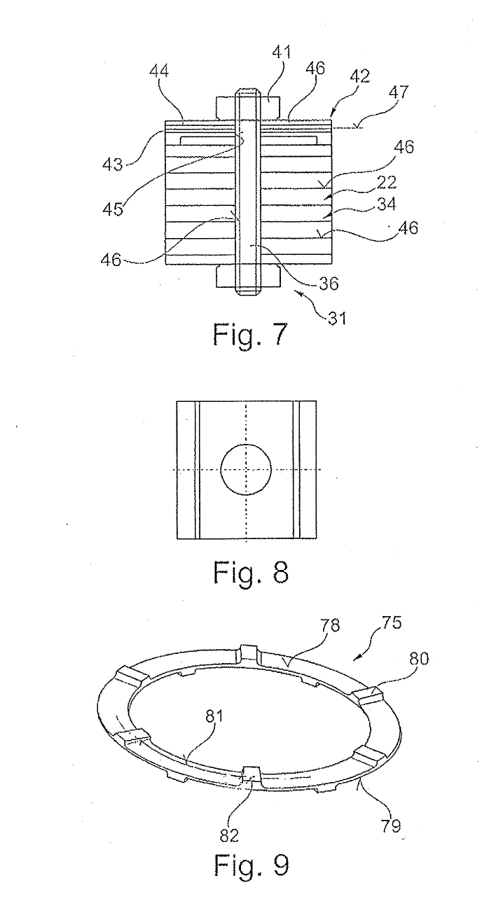

FIG. 7: shows an enlarged detail illustration of a screw-connection device on the circulation device illustrated in FIG. 1;

FIG. 8: shows a lateral view of a spring element used in the screw-connection device illustrated in FIG. 7;

FIG. 9: shows another embodiment of a spring element for a screw-connection device in an isometric illustration;

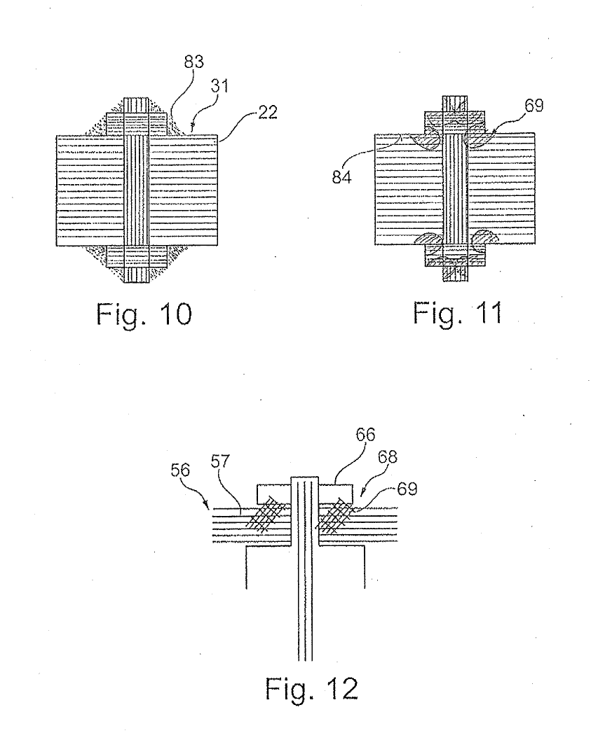

FIG. 10: shows an embodiment of a screw-connection device having a connecting material applied to the connecting zone between the components of the screw-connection device, said embodiment being an alternative to the screw-connection device illustrated in FIG. 7;

FIG. 11: shows the screw-connection device illustrated in FIG. 10 following a local welding of the components coated with the connecting material;

FIG. 12: shows an enlarged detail illustration of a screw-connection device on the circulation device illustrated in FIG. 6.

FIG. 1 shows a first embodiment of a circulation device 20 comprising a shaft 21 for connecting the circulation device 20 to a driving device (not illustrated) and a blade carrier 22 that is rigidly connected to the shaft 21 for co-rotation and is used for arranging thereon a plurality of blades 23 that are arranged in a distributed manner across the circumference of the blade carrier 22. As shown in FIG. 1, the blades 23 are accommodated between the blade carrier 22 and a conical end ring 24, for which purpose they are each inserted with their axial ends 27, 28 into slot-shaped recesses 29 of the blade carrier 22 and of the end ring 24 via form-fit connections 25 and 26, respectively.

As can be taken in particular from FIGS. 2 and 3, a plurality of screw-connection devices 31 is provided for connecting the shaft 21 to the blade carrier 22, said screw-connection devices being arranged concentrically to a center axis 30 of the circulation device 20. For connection to the blade carrier 22, the shaft 21 has a plate flange 33 that is formed on an axial connecting end 32 of the shaft 21 and that has a radially extending flange ring 34 that is in contact with a bottom side 35 of the disk-shaped blade carrier 22. The screw-connection devices 31 are realized in such a manner that a threaded bolt 36 penetrates passage holes 37, 38 in the flange ring 34 and in the blade carrier 22 and is provided with a nut 41 on each of its opposing axial ends 39, 40. In the embodiment example of the screw-connection device 31 illustrated in FIG. 2, a beam spring element 42 is arranged between the flange ring 34 and the nut 41 arranged at the lower axial end 40 of the threaded bold 36.

As can be taken from the detail illustration in FIG. 7, the beam spring element 42 has an elastic beam 44 that is supported with axial ends on support legs 43 and which is provided with a passage hole 45 for passage of the threaded bolt 36. The beam spring element 42 is realized as a CFC component having a fiber orientation 46 that within in the area of the elastic beam 44 extends in the direction of a stress axis 47 running between the support legs 43 so that, in case of a stress on the elastic beam 44 due to a pre-tension force acting in the screw-connection device 31, the resulting tensile stress in the elastic beam 44 can be absorbed by the fibers of the CFC component.

As further becomes clear from the schematic illustration of FIG. 7, which also indicates the fiber orientation 46 in the flange ring 34 of the shaft 21 and in the blade carrier 22 as well as in the threaded bolt 36, all components of the crew-connection device 31 illustrated exemplarily in FIG. 7 are realized as CFC components, except for the nuts 41, which are exclusively loaded by pressure. In principle, it is of course also possible to realize the nuts 41 as CFC components and the threaded bolt 36 as a graphite component or to realize both components identically.

Owing to the elastic flexibility of the beam spring element, the screw-connection device 31, more precisely the threaded bolt 36 of the screw-connection device, can be loaded with a sufficiently high pre-tension force so that even if settling phenomena occur in particular vertically to the fiber orientation 46 in the porous carbon material of the components that are clamped together with a pre-tension force, the components can compensate them by means of the elasticity of the beam spring element 42, and the components clamped together via the screw-connection device 31 can still fit against each other with sufficient force to effectively prevent relative motions of the components.

In the circulation device 50 illustrated in FIG. 4, a shaft 51 is connected to a blade carrier 54 by means of a connecting piece 53 that is arranged at an axial connecting end 52 of the shaft 51.

In the circulation device 50, blades 55 are accommodated between the blade carrier 54 and an end ring 56, which, as illustrated in FIG. 6, is realized as a plane annular disk 57 having an annular projection 59 integrally formed on an inner circumference 58 of the annular disk 57. For connecting the blades 55 to the blade carrier 54 and to the end ring 56, threaded bolts 62 are integrally formed on both the lower axial end 60 and the upper axial end 61 of the blades 55, said threaded bolts 62 penetrating passage holes 63 in the blade carrier 54 and passage holes 64 in the annular disk 57 of the end ring 56 and each being provided with a nut 66 at their free axial ends 65, which is preferably made of graphite.

The embodiment example of the circulation device 50 illustrated in FIG. 6 is different from the embodiment example of the circulation device 20 illustrated in FIGS. 1 to 3 in that the former is provided with screw-connection devices 67 that do not have a beam spring element 42. Instead of a beam spring element 42, the screw-connection devices 67 have an additional material-bonded connection 68, which, as illustrated in FIG. 12, is formed in a connecting zone 69 between the nut 66 and the annular disk 57 of the end ring 56.

As is shown in particular in FIG. 6, for connecting the shaft 51, the connecting piece 53 arranged at the axial connecting end 52 of the shaft 51 is guided through a central passage hole 71 with a threaded bolt 70 formed at the connecting piece 53 and is provided with a disk nut 73 at its free axial end 72, said nut, together with the threaded bolt 70, enabling a screw-connection device 74 for connecting the shaft 51 to the blade carrier 54.

Moreover, the screw-connection device 74 is provided with an annular spring element 75, which is illustrated as an individual component in FIG. 9 and is arranged between a bottom side 76 of the blade carrier 54 and the connecting piece 53 corresponding to the illustration in FIG. 6. The connecting piece 53, which is realized as a graphite component in the present embodiment example, is rigidly connected for co-rotation to the tubular shaft 51 via pin connections 77.

As FIG. 9 shows, the annular spring element 75 has two opposing axial surfaces 78, 79 on a spring ring 85, which are each provided with support legs 80 that are arranged in a circumferentially distributed manner.

The support legs 80 are arranged in such a way that each support leg arranged on an upper axial surface 78 is located between two support legs 80 arranged on the lower axial surface 79. The annular spring element 75 is realized as a CFC component having a fiber orientation 81 that, as indicated in FIG. 9, extends in the direction of a stress axis 82 running between the support legs 80 of the annular spring element 75. As explained before with reference to FIGS. 1 to 3 using the embodiment example of the beam spring element 42, the elastic flexibility of the annular spring element 75 allows compensation of settling phenomena in the screw-connection device 74.

With reference to the figure sequence of FIGS. 10 and 11, an option for producing the material-bonded connection 68 is explained in the following paragraphs, which is used in addition to a form-fitting connection 25, 26, as illustrated in FIG. 3, or alternatively also in addition to a screw-connection device.

As FIG. 10 shows using the example of the screw-connection device 31, first the screw-connection device 31 is coated in the area of the intended connecting zone 69 (FIG. 11) by applying a connecting material 83, which, in the present case, is applied as a pasty material and substantially consists of polyvinyl alcohol with a weight proportion of 50% silicon powder. Then the connecting system is heated to a temperature above 1400° C. in a protective gas atmosphere, causing the silicon powder to melt and react with the carbon of the CFC component to form silicon carbide, the CFC component being formed by the blade carrier 22 in the case of the present embodiment example.

As indicated by the schematic illustration in FIG. 11, the reaction results in the formation of the connecting zone 69, which has a silicon carbide content that decreases with growing distance from a boundary layer 84 formed between the components.

Instead of silicon, which is used as a carbide-forming agent in the aforedescribed embodiment example, it is also generally possible to use other carbide-forming agents, such as metals, in particular titanium, tantalum or chromium, to produce metal carbides in the connecting zone, or also other semiconductors than silicon, such as boron. In particular if carbon black is added to the silicon, the silicon is particularly suited as a carbide-forming agent because the occurrence of free silicon in the connecting zone can be limited to the furthest extent by the addition of carbon black in order to thus obtain a connecting zone that allows thermally stable material performance over a wide temperature range.

1. A component connection comprising:
at least two carbon fiber-reinforced carbon (CFC) components;
a connecting system interconnecting said at least two CFC components in a force fitting manner and exclusively having connecting elements consisting of CFC or graphite material; and
a spring element consisting of a CFC material.

2. The component connection according to claim 1, in which the connecting system is a screw-connection device that has a threaded bolt consisting of a CFC or graphite material and at least a nut consisting of a CFC or graphite material and the spring element is arranged between the nut and a CFC component in such a manner that a pressure force is active between the nut and the CFC component.

3. The component connection according to claim 2, in which the threaded bolt is provided with a bolt head and the threaded bolt penetrates two CFC components that are to be interconnected in a force-fitting manner and that are arranged between the bolt head of the threaded bolt and the nut.

4. The component connection according to claim 3, in which the bolt head is formed by a nut consisting of a CFC or graphite material.

5. The component connection according to claim 2, in which the threaded bolt is formed on a first one of the CFC components interconnected in a force fitting manner and penetrates the other CFC component, which is arranged between the first one of the CFC components and the nut.

6. The component connection according to claim 1, in which the spring element is beam spring element having two support legs for support on a CFC component and an elastic beam connecting the support legs for support on the bolt head or on the nut of the screw-connection device.

7. The component connection according to claim 1, in which the spring element is an annular spring element having a spring ring that has support legs on two opposing axial surfaces, said support legs being arranged on the axial surfaces in a radially distributed manner so that a support leg formed on one axial surface of the two opposing axial surfaces is arranged between two support legs formed on an opposite axial surface of the two opposing axial surface.

8. The component connection according to claim 6, in which at least the elastic beam of the beam spring element has a fiber orientation with fibers that extend along a stress axis connecting the support legs.

9. The component connection according to claim 1, implemented on a circulation device circulating an ambient atmosphere, the circulation device having a plurality of components that comprise at least a shaft for connecting the circulation device to a driving device, a blade carrier connected to the shaft and a plurality of blades arranged on the blade carrier for applying a flow impulse to the atmosphere, in such a manner that at least the blade carrier and the blades are realized as CFC components between which the component connection is formed.

10. The component connection according to claim 7, in which at least the spring ring of the annular spring element has a fiber orientation with fibers that extend along a stress axis connecting the support legs.
